(19) United States
(12) Patent Application Publication
(10) Pub. No.: US 2019/0296301 A1
(43) Pub. Date: Sep. 26, 2019

(54) SEALING STRUCTURE AND ELECTRONIC DEVICE

(71) Applicant: JVC KENWOOD Corporation, Yokohama-shi (JP)

(72) Inventors: Takashi Hori, Yokohama-shi (JP); Hideaki Suzuki, Yokohama-shi (JP); Hiroyuki Gunji, Yokohama-shi (JP)

(21) Appl. No.: 16/276,840

(22) Filed: Feb. 15, 2019

(30) Foreign Application Priority Data
Mar. 20, 2018 (JP) 2018-052250

(51) Int. Cl. H01M 2/10

(52) U.S. Cl. CPC H01M 2/1094; H04B 1/3827

(57) ABSTRACT

A sealing structure includes a main body, a lid that seals an opening of the main body, a slide unit provided in the lid and slidable along the main body, and a plurality of protrusions provided along the sliding direction of the slide unit at the opening of the main body. The slide unit includes a plurality of lock levers provided to correspond to the plurality of protrusions, and claws that engage with the plurality of protrusions at the time when the slide unit slides in a predetermined direction.

### CROSS-REFERENCE TO RELATED APPLICATIONS

This application claims priority from Japanese Application No. 2018-052250, filed on Mar. 20, 2018, the contents of which are incorporated by reference herein in its entirety.

### BACKGROUND

### 1. Technical Field

The present disclosure relates to a sealing structure and an electronic device.

### 2. Description of the Related Art

There has been known a locking mechanism having a slide lever structure for closing a battery lid of an electronic device or the like.

For example, JP 3580673 B2 discloses a locking mechanism in which a lock lever including a lock claw slides to engage the lock claw with a locking part provided in a camera body, thereby attaching a battery lid to the camera body.

According to JP 3580673 B2, in a case where an engagement margin of the lock claw is increased to secure strength, a stroke distance for locking the battery lid increases. In this case, it is difficult to downsize the locking mechanism, and the battery lid may be easily inclined as the stroke distance is long.

### SUMMARY

It is an object of the present disclosure to at least partially solve the problems in the conventional technology.

A sealing structure according to a first embodiment of the present disclosure includes a main body, a lid that seals an opening of the main body, a slide unit provided in the lid and slidable along the main body, and a plurality of protrusions provided along a sliding direction of the slide unit at the opening of the main body. The slide unit includes a plurality of lock levers provided to correspond to the plurality of protrusions, and a claw that engages with the plurality of protrusions at a time when the slide unit slides in a predetermined direction.

An electronic device according to a second embodiment of the present disclosure includes the sealing structure according to the first embodiment.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a view illustrating an exemplary electronic device having a sealing structure according to an embodiment of the present disclosure;

FIG. 2 is a cross-sectional view of a conventional sealing structure;

FIG. 3 is a diagram for illustrating a stroke distance of the conventional sealing structure;

FIG. 4 is a cross-sectional view of the sealing structure according to the embodiment of the present disclosure;

FIG. 5 is a diagram for illustrating a stroke distance according to the embodiment of the present disclosure; and

FIG. 6 is a diagram for illustrating a method of attaching a lid to a main body in the sealing structure according to the embodiment of the present disclosure.

### DETAILED DESCRIPTION OF THE PREFERRED EMBODIMENTS

Hereinafter, an embodiment of the present disclosure will be described in detail with reference to the accompanying drawings. Note that, in the drawings, the same or corresponding portions are denoted by the same reference signs, and descriptions thereof will be omitted as appropriate.

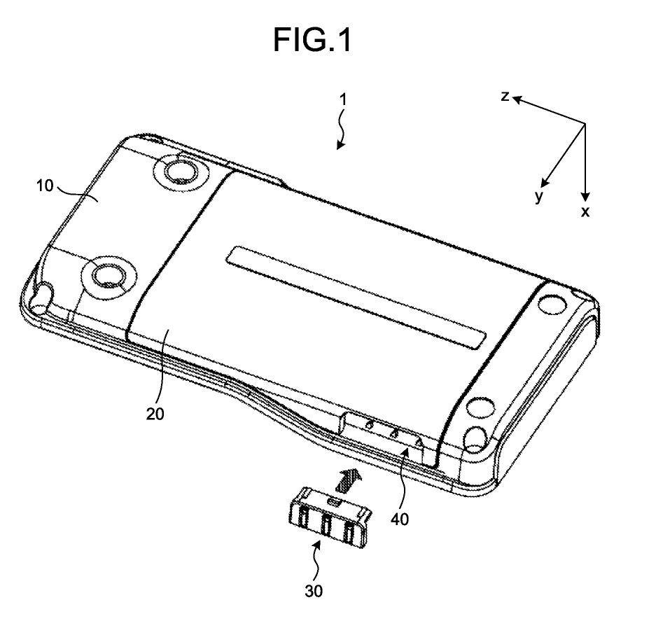

An electronic device having a sealing structure according to the present disclosure will be described with reference to FIG. 1. FIG. 1 is a view illustrating an electronic device having a sealing structure according to an embodiment of the present disclosure. Note that a rectangular coordinate system is used in each of the following drawings. Specifically, an x direction is an anterior-posterior direction, a y direction is a crosswise direction, and a z direction is a superior-inferior direction.

As illustrated in FIG. 1, an electronic device 1 includes a main body 10, a lid 20, and a slide unit 30. Although the slide unit 30 is separated from the lid 20 in FIG. 1, the slide unit 30 is slidably coupled to the lid 20. The electronic device 1 is, for example, a wireless terminal such as a transceiver. The present embodiment can be suitably applied to a wireless terminal such as a transceiver. Note that the present disclosure is not limited to electronic devices, and can be applied to any structure in which an opening of a main body is sealed by a lid.

The main body 10 is a main body part of the electronic device 1, which includes, for example, an opening 40 to accommodate a battery. The lid 20 is a lid for sealing the opening 40 of the main body 10. Specifically, the lid 20 seals the opening 40 of the main body 10, for example. FIG. 1 illustrates a state in which the opening 40 of the main body 10 is sealed by the lid 20. The slide unit 30 is a component for attaching the lid 20 to the main body 10. Specifically, the slide unit 30 is provided in the lid 20, which is slid in the state where the lid 20 covers the opening 40 of the main body 10, whereby the slide unit 30 can be attached in such a manner that the lid 20 seals the opening 40 of the main body 10. This state in which the opening 40 of the main body 10 is sealed by the lid 20 is referred to as a locked state. Conversely, a state in which the slide unit 30 slides in the opposite direction and the lid 20 enters a state disengageable from the main body 10 is referred to as a released state.

In the electronic device 1 illustrated in FIG. 1, the lid 20 can be attached to the main body 10 by the slide unit 30 being moved in the superior-inferior direction. By moving the slide unit 30 in the superior-inferior direction, the locked state and the released state of the lid 20 can be switched. Specifically, in FIG. 1, the direction along the z axis is the sliding direction, one of the sliding directions (downward direction of the electronic device 1) is the locking direction, and the other one of the sliding directions (upward direction of the electronic device 1) is the releasing direction. That is, the electronic device 1 has a sealing structure in which the locked state and the released state of the lid 20 are switched by the slide unit 30 being moved up and down with respect to the electronic device 1.

Although the sealing structure of one side surface along the superior-inferior direction is illustrated in FIG. 1, a similar sealing structure may be provided on the facing other side surface of the electronic device 1. In this case, the locking direction and the releasing direction of the sealing structure on both side surfaces may be the same or may be different. Further, although the electronic device 1 has the sealing structure along the superior-inferior direction, it may have a sealing structure along the crosswise direction.

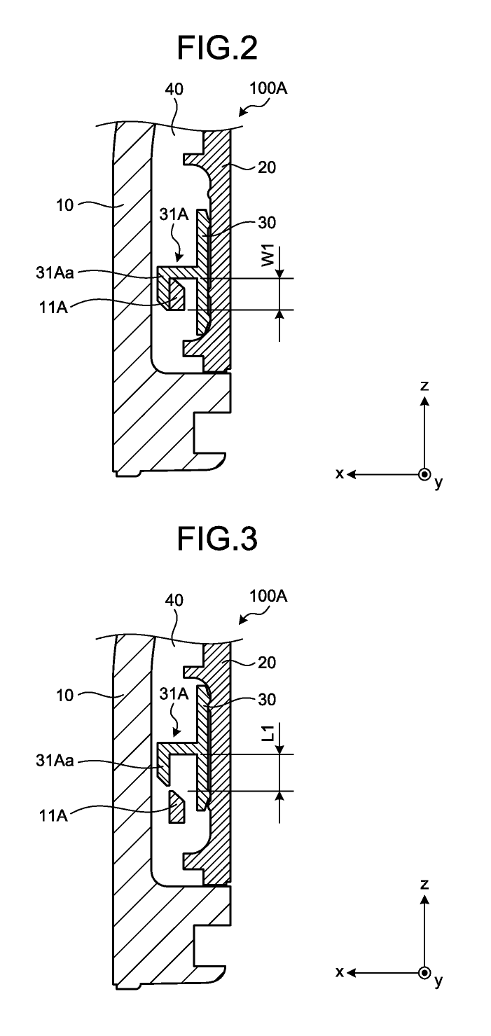

First, a conventional sealing structure will be described with reference to FIGS. 2 and 3 to facilitate understanding of the present disclosure. FIG. 2 is a cross-sectional view of the conventional sealing structure. FIG. 3 is a diagram for illustrating a stroke distance of the conventional sealing structure.

As illustrated in FIG. 2, in a conventional sealing structure 100A, the main body 10 includes a protrusion 11A in the opening 40. The slide unit 30 provided in the lid 20 includes a lock lever 31A. The lock lever 31A includes a claw 31Aa that engages (hooks) with the protrusion 11A in the locked state. That is, in the sealing structure 100A, the slide unit 30 includes only one lock lever 31A, and the opening 40 of the main body 10 is sealed with the lid 20 by the claw 31Aa of the lock lever 31A and the protrusion 11A of the main body 10 being engaged with each other. In this manner, the lid 20 is attached to the main body 10. In this case, a length W1 of the engagement margin between the protrusion 11A and the claw 31Aa is, for example, 3 mm.

With reference to FIG. 3, operation of sliding the slide unit 30 for sealing the opening 40 of the main body 10 with the lid 20 in the released state will be described. A stroke distance L1 of the slide unit 30 for sealing the opening 40 of the main body 10 with the lid 20 is, for example, on the assumption that a dimensional error is 0.5 mm, as the engagement margin is 3 mm, 3+0.5=3.5 mm.

As illustrated in FIGS. 2 and 3, conventionally, the engagement margin is enlarged to increase strength so that the stroke distance also increases accordingly, thereby increasing a size of the structure. In addition, since the stroke distance increases, the lid 20 may be attached to the main body 10 in an inclined state in some cases.

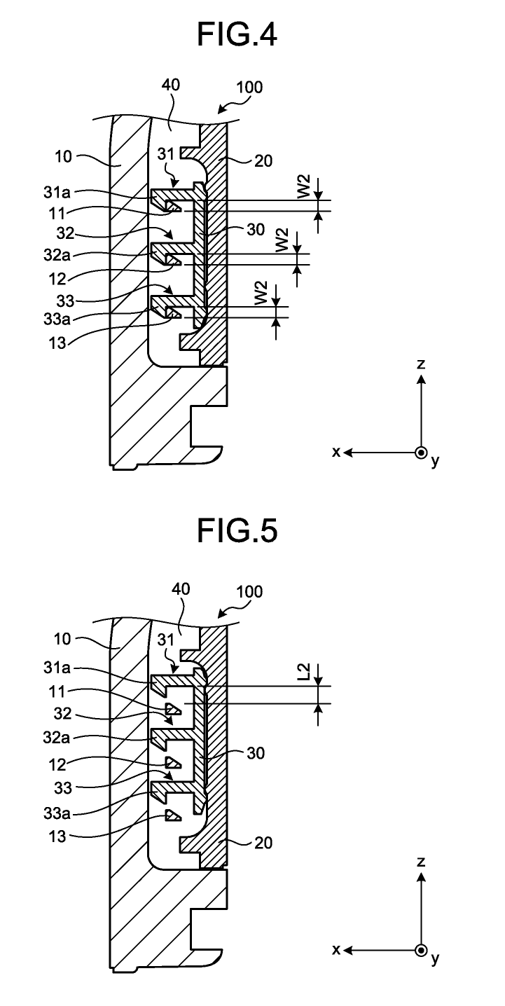

Next, the sealing structure according to the embodiment of the present disclosure will be described with reference to FIGS. 4 and 5. FIG. 4 is a cross-sectional view of the sealing structure in FIG. 1 according to the embodiment of the present disclosure. FIG. 5 is a diagram for illustrating the stroke distance of the sealing structure according to the embodiment of the present disclosure.

As illustrated in FIG. 4, in the sealing structure according to the present embodiment, the main body 10 includes, in the opening 40, a first protrusion 11, a second protrusion 12, and a third protrusion 13 along the sliding direction of the slide unit 30. The slide unit 30 includes a first lock lever 31, a second lock lever 32, and a third lock lever 33 along the sliding direction of the slide unit 30.

The first lock lever 31 includes a first claw 31a that engages with the first protrusion 11 in the locked state. The second lock lever 32 includes a second claw 32a that engages with the second protrusion 12 in the locked state. The third lock lever 33 includes a third claw 33a that engages with the third protrusion 13 in the locked state.

That is, in the present embodiment, the slide unit 30 includes three lock levers of the first lock lever 31 to the third lock lever 33, and in the present embodiment, the first claw 31a to the third claw 33a engage with the first protrusion 11 to the third protrusion 13 of the main body 10, respectively, whereby the opening 40 of the main body 10 is sealed by the lid 20. In this manner, the lid 20 is attached to the main body 10.

The first lock lever 31, the second lock lever 32, and the third lock lever 33 have the same shape. A distance between the first lock lever 31 and the second lock lever 32 and a distance between the second lock lever 32 and the third lock lever 33 may be the same, or may be different. In the case where the distance between the first lock lever 31 and the second lock lever 32 and the distance between the second lock lever 32 and the third lock lever 33 are made different, respective claws are only required to be engaged with corresponding protrusions simultaneously when the slide unit 30 slides in the locking direction.

As illustrated in FIG. 4, an engagement margin between the first claw 31a and the first protrusion 11, an engagement margin between the second claw 32a and the second protrusion 12, and an engagement margin between the third claw 33a and the third protrusion 13 have the same length, that is, W2. In a case where one lock lever is provided on the slide unit 30 and an engagement margin between the lock lever and the protrusion of the main body is 3 mm, W2 is 3 mm/3=1 mm. That is, the sealing structure according to the present embodiment has a structure in which the lock lever is divided into a plurality of lock levers so that the lengths of the engagement margins between respective claws formed on respective lock levers and protrusions corresponding to the respective lock levers are shortened. In the case where the lock lever is divided into three to shorten the engagement margin between each claw and the corresponding protrusion, the length of the engagement margin is not limited to 1 mm, and may be, for example, 2 mm depending on the design. Note that the length of the engagement margin is preferably 1 mm or more from the viewpoint of operability.

In the present embodiment, the lid 20 is attached to the main body 10 by being secured at three positions, that is, the first claw 31a, the second claw 32a, and the third claw 33a. Specifically, the lid 20 is secured over a wide range between the central portion and the both end portions of the slide unit 30 in the sliding direction, thereby sealing the opening 40 of the main body 10. As a result, a close contact property between the main body 10 and the lid 20 is improved, and the lid 20 can be stably attached to the main body 10, whereby rattling of the main body 10 and the lid 20 and an inclination of the lid 20 with respect to the main body 10 can be suppressed.

Thicknesses of the first claw 31a, the second claw 32a, and the third claw 33a in the crosswise direction may be the same, or may be different. For example, in a case where, out of the first claw 31a, the second claw 32a, and the third claw 33a, only one claw needs to be made thin for the convenience of design, only one claw may be thinly formed. For example, if there is room in the space, out of the first claw 31a, the second claw 32a, and a third claw 33a, only a specific claw may be thickly formed to improve the strength.

With reference to FIG. 5, the operation of sliding the slide unit 30 for sealing the opening 40 of the main body 10 with the lid 20 in the released state will be described. In order to seal the opening 40 of the main body 10 with the lid 20, for example, on the assumption that a dimensional error is 0.5 mm, as the engagement margin is 1 mm, a stroke distance L2 is 1+0.5=1.5 mm. That is, the lock lever is divided to form the claw on each of them so that the length of the engagement margin can be made short compared with the case of one lock lever, whereby the stroke distance can also be made short. The stroke distance is not limited to 1.5 mm, and the stroke distance may be lengthened depending on the design.

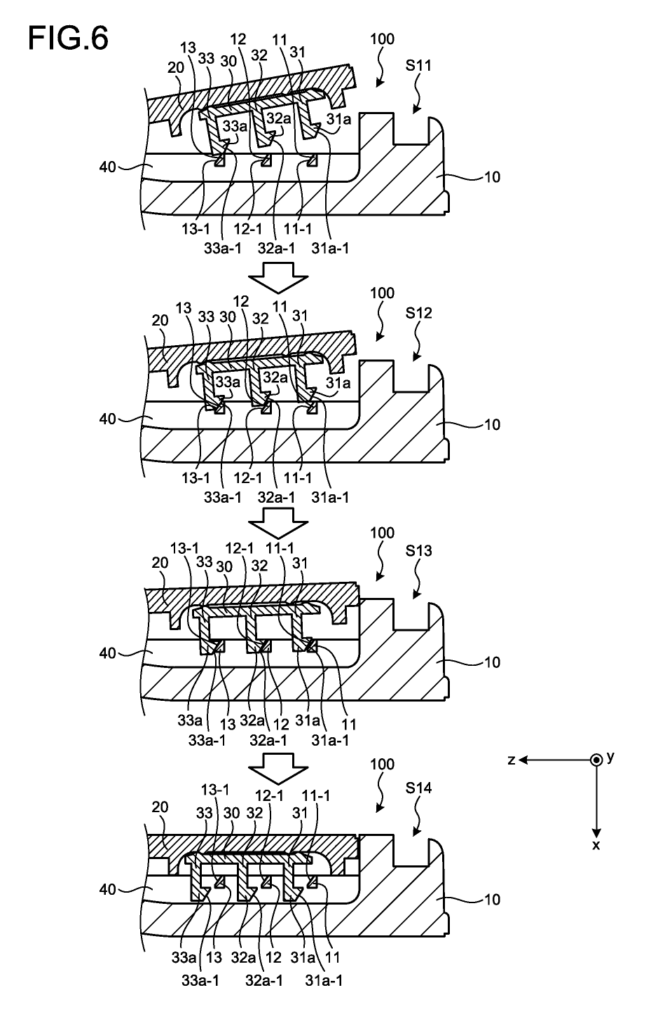

With reference to FIG. 6, operation of moving the slide unit 30 to a release position in a case where the lid 20 seals the opening 40 of the main body 10 from a state in which the lid 20 is separated from the main body 10 while the slide unit 30 remains at the position of the locked state will be described. FIG. 6 is a diagram for illustrating the operation of moving the slide unit 30 to the release position.

As illustrated in FIG. 6, the first claw 31a, the second claw 32a, and the third claw 33a include a first claw-side inclined surface 31a-1, a second claw-side inclined surface 32a-1, and a third claw-side inclined surface 33a-1, respectively. The first protrusion 11, the second protrusion 12, and the third protrusion 13 include a first protrusion-side inclined surface 11-1, a second protrusion-side inclined surface 12-1, and a third protrusion-side inclined surface 13-1, respectively. In the present embodiment, when the lid 20 is pressed against the main body 10 in the direction from the back surface toward the front surface (x direction in FIG. 6), the first claw-side inclined surface 31a-1 to the third claw-side inclined surface 33a-1 engage with the first protrusion-side inclined surface 11-1 to the third protrusion-side inclined surface 13-1, respectively, thereby moving the slide unit 30 to the release position. In FIG. 6, the right direction is the locking direction, and the left direction is the releasing direction.

Inclination angles of the first claw-side inclined surface 31a-1, the second claw-side inclined surface 32a-1, and the third claw-side inclined surface 33a-1 are preferably the same. Inclination angles of the first protrusion-side inclined surface 11-1, the second protrusion-side inclined surface 12-1, and the third protrusion-side inclined surface 13-1 are the same of the inclination angles of the first claw-side inclined surface 31a-1, the second claw-side inclined surface 32a-1, and the third claw-side inclined surface 33a-1, respectively. Although the inclination angle is not limited, an acute angle smaller than 45° is preferable to make the slide unit 30 move easily from the release position to the lock position.

First, as illustrated in S11, while the slide unit 30 remains at the position of the locked state, the lid 20 intends to seal the opening 40 of the main body 10.

Next, as illustrated in S12, the first claw-side inclined surface 31a-1 to the third claw-side inclined surface 33a-1 are brought into contact with the first protrusion-side inclined surface 11-1 to the third protrusion-side inclined surface 13-1, respectively.

Next, as illustrated in S13, as the lid 20 is pressed in the x direction, the first claw-side inclined surface 31a-1 to the third claw-side inclined surface 33a-1 move by sliding on the first protrusion-side inclined surface 11-1 to the third protrusion-side inclined surface 13-1, respectively. That is, as the lid 20 is pressed in the x direction, the slide unit 30 is moved from the position of the locked state to the position of the released state.

Then, as illustrated in S14, the slide unit 30 is moved from the position of the locked state to the position of the released state, and the opening 40 of the main body 10 is covered by the lid 20. In this state, the slide unit 30 is moved to the position of the locked state, whereby the opening 40 of the main body 10 is sealed by the lid 20.

Note that, although the slide unit 30 includes three lock levers of the first lock lever 31, the second lock lever 32, and the third lock lever 33 in the present embodiment, this is an example and the present disclosure is not limited thereto. According to the present disclosure, for example, the slide unit 30 may include two lock levers or four or more lock levers. In other words, the slide unit 30 only needs to include a plurality of lock levers.

Specifically, as the number of the lock levers provided on the slide unit 30 increases, the length of the engagement margin can be shortened and the stroke distance is shortened. For example, the stroke distance in the case where the number of lock levers formed on the slide unit 30 is N (N is an integer of two or more) is, on the assumption that the stroke distance is L mm in the case of one lock lever, L/N mm. The number of lock levers formed on the slide unit 30 may be determined on the basis of design items such as a width in the sliding direction, strength, and operability of the slide unit 30, for example.

As described above, in the present embodiment, in the sealing structure for sealing the main body and the lid with the slide unit, the lock lever provided on the slide unit is formed by dividing it into a plurality of lock levers. Accordingly, the length of the engagement margin between the claw included in the lock lever and the protrusion can be shortened, whereby the stroke distance can be shortened while the strength at the time of locking is maintained. As the stroke distance for locking is shortened, opening and closing operations are simplified, and it also becomes advantageous from the viewpoint of miniaturization.

Further, in the present embodiment, the lock lever is divided into a plurality of lock levers to achieve a sealing structure with the short stroke distance, whereby rattling of the main body and the lid and an inclination of the lid with respect to the main body can be suppressed.

Furthermore, in the present embodiment, the claw has the claw-side inclined surface, and the protrusion has the protrusion-side inclined surface. In addition, in the present embodiment, when the lid is attached to the main body while the slide unit is in the locked state, the claw-side inclined surface and the protrusion-side inclined surface are brought into contact with each other. In the present embodiment, the claw-side inclined surface and the protrusion-side inclined surface are brought into contact with each other, whereby the slide unit receives force in the moving direction from the position of the locked state to the position of the released state. Accordingly, in the present embodiment, since the stroke distance for switching the locked state and the released state of the slide unit is short, it is easily moved from the locked state to the released state, and the main body and the lid can be attached. Therefore, according to the present embodiment, breakage of the claw or the like can be prevented at the time of attaching the lid to the main body.

According to the present disclosure, a stroke distance for locking can be shortened while strength at the time of locking is maintained.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sealing structure, comprising:
a main body;
a lid that seals an opening of the main body;
a slide unit provided in the lid and slidable along the main body; and
a plurality of protrusions provided along a sliding direction of the slide unit at the opening of the main body, wherein
the slide unit includes:
a plurality of lock levers provided to correspond to the plurality of protrusions; and
a claw that engages with the plurality of protrusions at a time when the slide unit slides in a predetermined direction.

2. The sealing structure according to claim 1, wherein a length of the claw is determined according to the number of the lock levers provided on the slide unit.

3. The sealing structure according to claim 2, wherein the length of the claw decreases as the number of the lock levers provided on the slide unit increases.

4. An electronic device, comprising: the sealing structure according to claim 1.
